(19) United States
(12) Patent Application Publication
(10) Pub. No.: US 2025/0245925 A1
(43) Pub. Date: Jul. 31, 2025

(54) STORAGE MEDIUM, INFORMATION PROCESSING SYSTEM, INFORMATION PROCESSING APPARATUS AND INFORMATION PROCESSING METHOD

(71) Applicant: NINTENDO CO., LTD., Kyoto (JP)

(72) Inventor: Wataru TANAKA, Kyoto (JP)

(21) Appl. No.: 19/037,780

(22) Filed: Jan. 27, 2025

(30) Foreign Application Priority Data
Jan. 30, 2024 (JP) 2024-011591

(51) Int. Cl. G06T 17/20

(52) U.S. Cl. CPC G06T 17/20

(57) ABSTRACT

An example of an information processing system is configured to generate particle data including data representing positions of a plurality of particles that correspond to a shape of an existing object, which is an object arranged in a virtual space. The information processing system calculates change over time of the positions of the plurality of particles and updates the particle data based on the calculation result. The information processing system generates voxel data related to a voxel object, which has a shape corresponding to the positions of the plurality of particles, based on the particle data. The information processing system generates a mesh for the voxel object based on the voxel data. The information processing system generates an image that is obtained by rendering the mesh in the virtual space so as to output the generated image to a display device.

### CROSS REFERENCE TO RELATED APPLICATION

This application claims priority to Japanese Patent Application No. 2024-011591, filed on Jan. 30, 2024, the entire contents of which are incorporated herein by reference.

### FIELD

The present disclosure relates to a storage medium, an information processing system, an information processing apparatus, and an information processing method for generating objects in a virtual space using voxel data.

### BACKGROUND AND SUMMARY

There are conventional techniques for performing fluid simulations using particles and visualizing the simulation results using voxels.

With the conventional techniques, existing objects arranged in a virtual space are not deformed over time using particles.

Therefore, the present application discloses a storage medium, an information processing system, an information processing apparatus and an information processing method, with which it is possible to deform existing objects arranged in a virtual space over time using particles.

(1)

An example of one or more non-transitory computer-readable storage medium having stored therein instructions that, when executed, cause one or more processors of an information processing apparatus to execute information processing comprising: generating particle data including data representing positions of a plurality of particles that correspond to a shape of an existing object, which is an object arranged in a virtual space; calculating change over time of the positions of the plurality of particles and updating the particle data based on the calculation result; generating voxel data related to a voxel object, which has a shape corresponding to the positions of the plurality of particles, based on the particle data; generating a mesh for the voxel object based on the voxel data; and generating an image that is obtained by rendering the mesh in the virtual space so as to output the generated image to a display device.

With configuration (1) above, an existing object can be deformed over time using particle data.

(2)

The existing object may be an object generated based on voxel data that is generated before the particle data related to the existing object is generated.

With configuration (2) above, a voxel object arranged in a virtual space can be deformed over time using particles.

(3)

The particle data may be generated based on whether or not at least a part of the existing object is present in each of a plurality of unit regions that are obtained by partitioning a region including the existing object in the virtual space into a grid.

With configuration (3) above, it is possible to generate, with a small amount of calculation, particle data representing a group of particles arranged according to the shape of the existing object.

(4)

A length of one side of the unit region may be equal to a length of one side of a voxel corresponding to the voxel data generated based on the particle data.

With configuration (4) above, it is possible to generate a voxel object that sufficiently shows the shape represented by a plurality of particles, and also to reduce the processing load by reducing the number of particles.

(5)

The particle data may be updated so that at least some of the plurality of particles disappear in response to satisfaction of a disappearance condition.

With configuration (5) above, it is possible to express an object gradually becoming smaller while deforming.

(6)

The particle data may be updated repeatedly. A value of the current particle data may be calculated, which represents new positions of the plurality of particles, by using the previously updated particle data, without using the voxel data generated based on the previously updated particle data.

With configuration (6) above, it is possible to precisely calculate the positions of the particles having been moved by using previously updated particle data.

(7)

The storage medium may store instructions that cause the information processing apparatus to perform operations further comprising: updating a range of a voxel space, in which voxels related to the voxel data generated based on the particle data are set, based on the updated particle data.

With configuration (7) above, it is possible to reduce the possibility that the particles having been moved are located outside the sub-voxel space.

(8)

The positions of the plurality of particles may be controlled so that the particles are located within a voxel space, in which voxels related to the voxel data generated based on the particle data are set.

With configuration (8) above, it is possible to further reduce the possibility that the particles are located outside the sub-voxel space.

(9)

The particle data corresponding to the existing object may be generated in response to the existing object contacting a first object different from the existing object.

With configuration (9) above, it is possible to reduce the processing load by not generating particle data in the period before contact, when there is no need to deform the existing object.

(10)

The particle data corresponding to the existing object may be generated at least on a condition that a material set for the existing object and a material set for the first object are in a predetermined combination.

With configuration (10) above, it is possible to express the existing object deforming in response to contacting a particular object.

(11)

The storage medium may store instructions that cause the information processing apparatus to perform operations further comprising: determining whether or not the particles have contacted a second object different from the voxel object or whether or not the voxel object has contacted the second object; and if it is determined that the particles have contacted the second object or if it is determined that the voxel object has contacted the second object, causing a portion of the second object that has been contacted to disappear from the virtual space.

With configuration (11) above, it is possible to express how another object is made to disappear by the voxel object.

(12)

The contacted portion of the second object may disappear from the virtual space at least on a condition that a material set for the voxel object or the existing object and a material set for the second object are in a predetermined combination.

With configuration (12) above, the voxel object can cause a particular object to disappear while not causing objects other than the particular object to disappear.

(13)

The particle data may be updated so that the plurality of particles move over time toward destination positions that are set respectively for the plurality of particles.

With configuration (13) above, it is possible to easily move particles to desired positions, making it easy to perform the process of deforming an object into a desired shape.

(14)

The information processing apparatus may store data representing target positions of the plurality of particles, which are positions of the particles after change over time. The destination positions may be set based on the target positions, and the particle data may be updated until the plurality of particles reach the respective target positions.

With configuration (14) above, it is possible to move a plurality of particles to any positions and to deform an object into a desired shape.

(15)

The information processing apparatus may store post-change data related to a shape of an object after the existing object has changed over time. A mesh for the voxel object may be generated based on the voxel data based on the particle data at least until the plurality of particles reach the respective target positions. At a predetermined point in time after the plurality of particles have reached the respective target positions, mesh generation based on the voxel data based on the particle data may be ended, and a mesh may be generated based on the post-change data.

With configuration (15) above, the shape of an object having been deformed can be adjusted to a shape of a good precision.

Note that the present specification discloses an example of an information processing apparatus (e.g., a terminal device or a server) and an information processing system for executing processes recited in (1) to (15) above. The present specification also discloses an example of an information processing method (specifically, the game process method) by which the information processing system executes the various processes recited in (1) to (15) above.

With the storage medium, the information processing system, the information processing apparatus and the information processing method described above, existing objects arranged in a virtual space can be deformed over time using particles.

These and other features, aspects and advantages of the subject matter described herein will become more apparent from the following detailed description of the present invention when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a diagram showing an example of content of voxel data and content of material information;

FIG. 12 is a diagram showing an example of property information representing properties of materials;

FIG. 13 is a diagram showing an example of texture information representing textures of materials;

FIG. 14 is a diagram showing a method for generating a mesh;

FIG. 15 is a view showing an example of a game image including a terrain object;

FIG. 16 is a view showing an example of a primary voxel object and a sub-voxel object;

FIG. 17 is a view showing an example of a game space in which an ice object is arranged;

FIG. 18 is a view showing an example of a state where the ice object 222 contacts a lava terrain object 223 from the state shown in FIG. 17;

FIG. 19 is a view showing an example of a state where the ice object deforms from the state shown in FIG. 18;

FIG. 20 is a view showing an example of a process for deforming an object using particle data;

FIG. 21 is a view showing an example of setting a plurality of particles based on an existing object;

FIG. 22 is a view showing an example of generating a deformed object 233 from a group of particles 232;

FIG. 23 is a view showing an example of a process for moving a sub-voxel space;

FIG. 24 is a view showing an example of a process for modifying the positions of particles;

FIG. 25 is a view showing an example of how a voxel object grows larger;

FIG. 26 is a view showing an example of how another object is made to disappear by a deformed object;

FIG. 27 is a chart showing an example of various data used in information processes performed in a non-limiting game system;

FIG. 28 is a flow chart showing an example of a flow of a game process executed by a non-limiting game system; and

FIG. 29 is a sub-flow chart showing an example of a detailed flow of a particle process of step S5 shown in FIG. 28.

### DETAILED DESCRIPTION OF NON-LIMITING EXAMPLE EMBODIMENTS

### [1. Configuration of Game System]

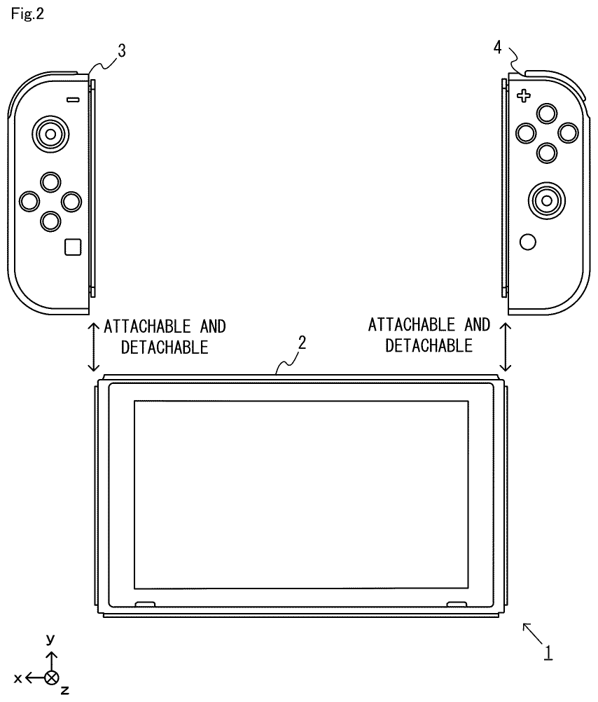

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

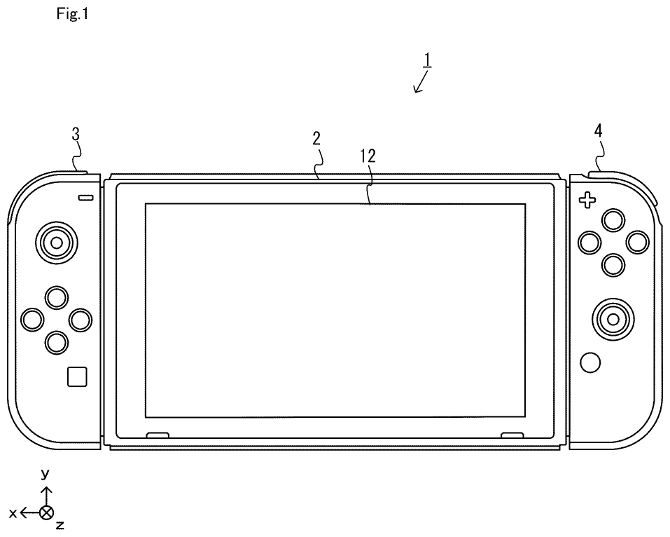

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

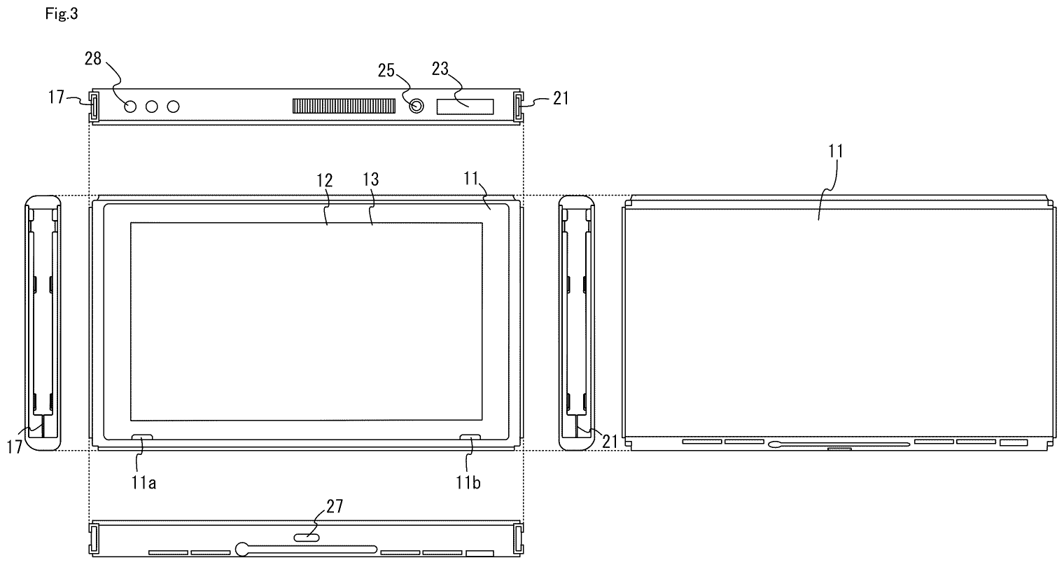

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

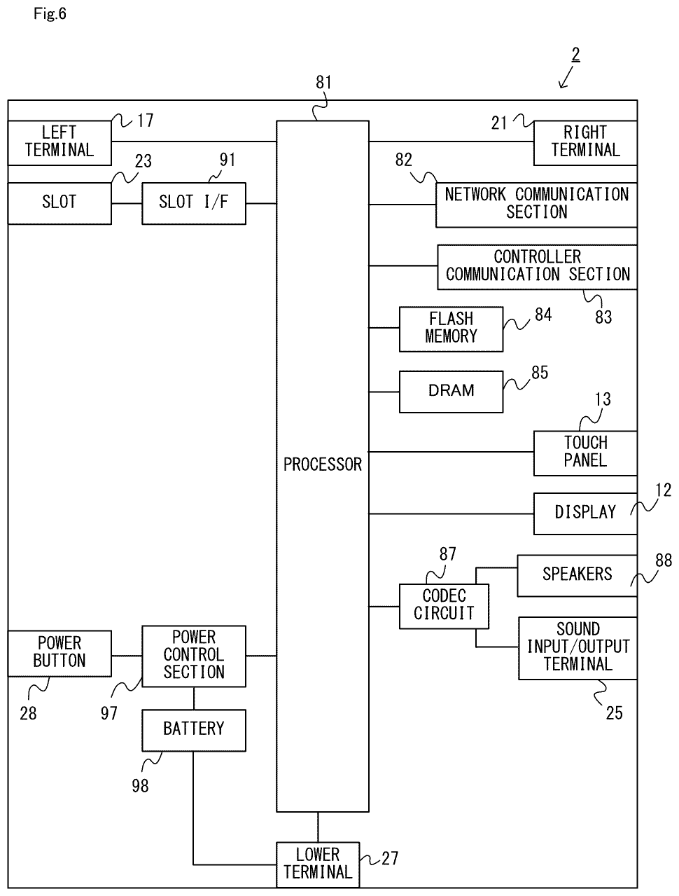

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

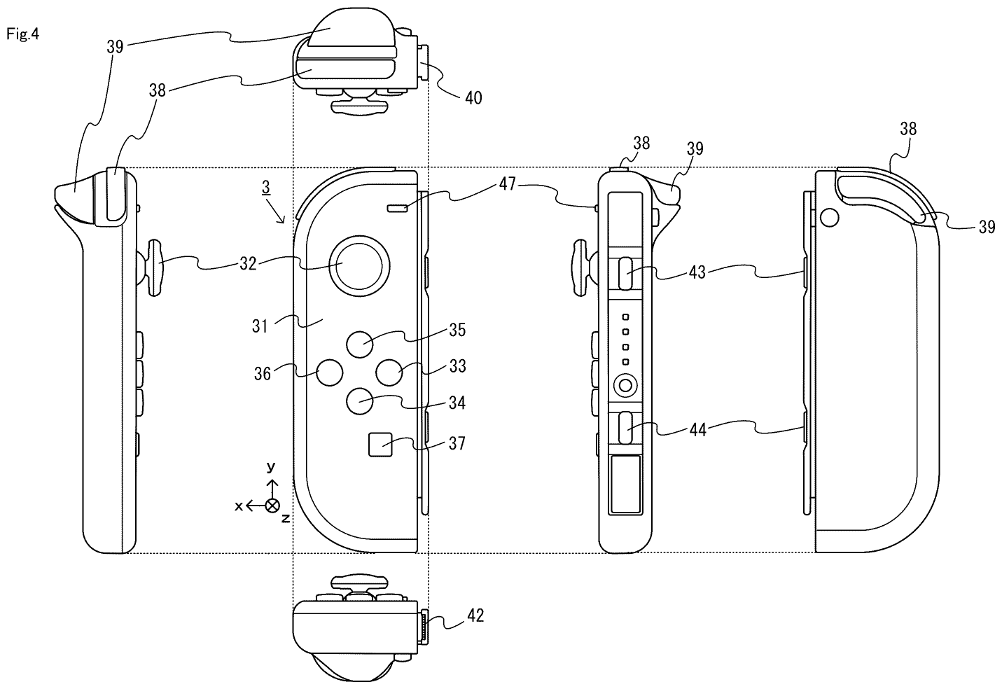

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

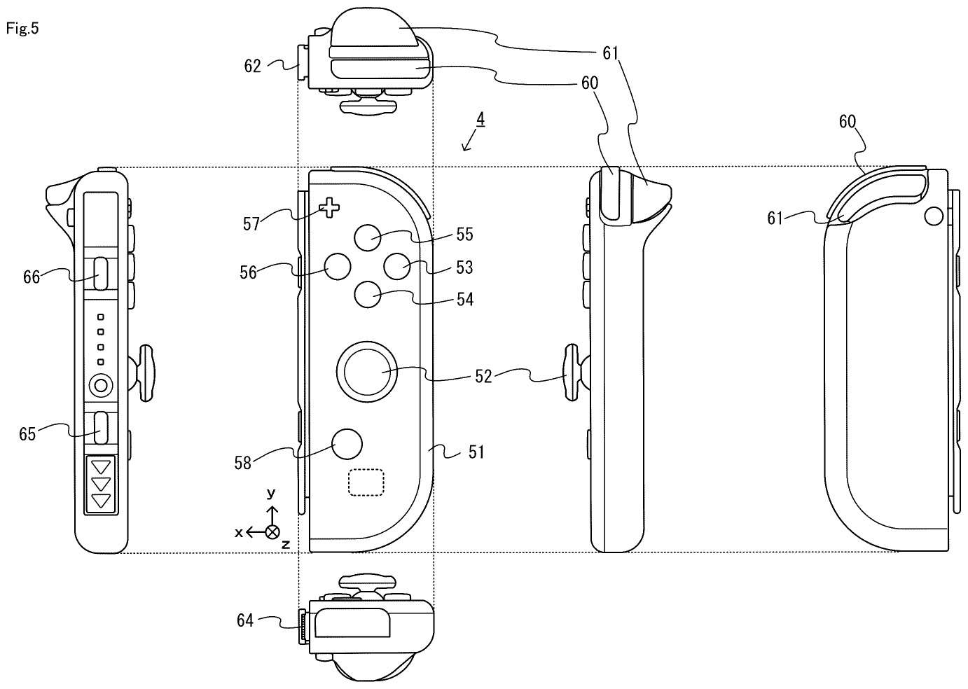

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external non-transitory storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

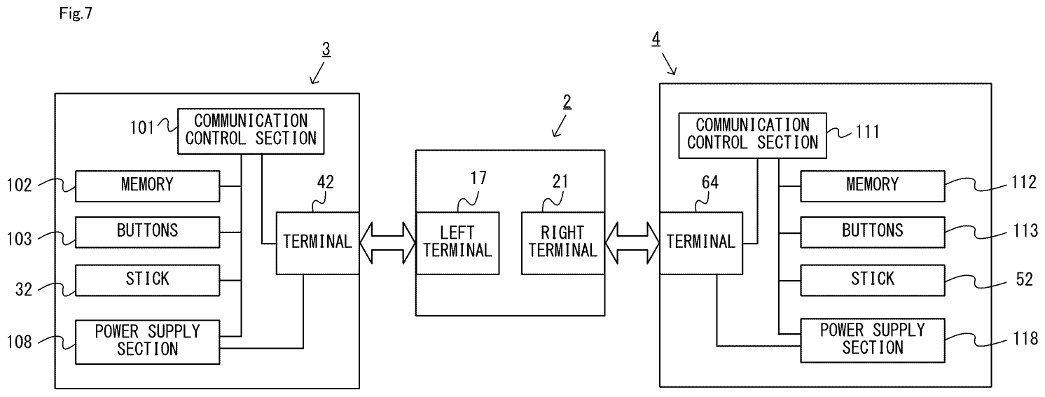

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

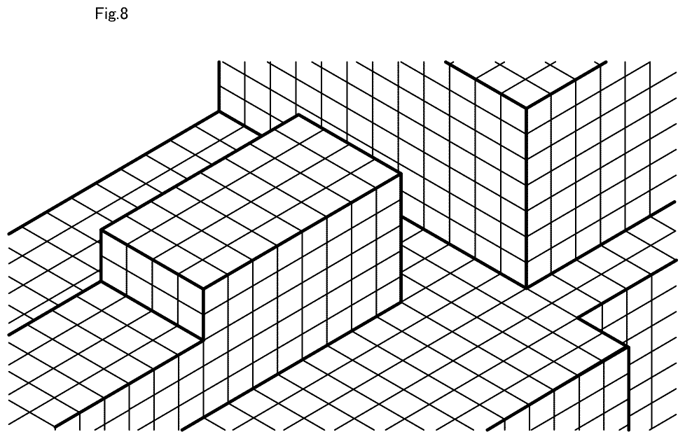

Next, referring to FIG. 8 to FIG. 21, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a stationary monitor.

### [2-1. Voxel]

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

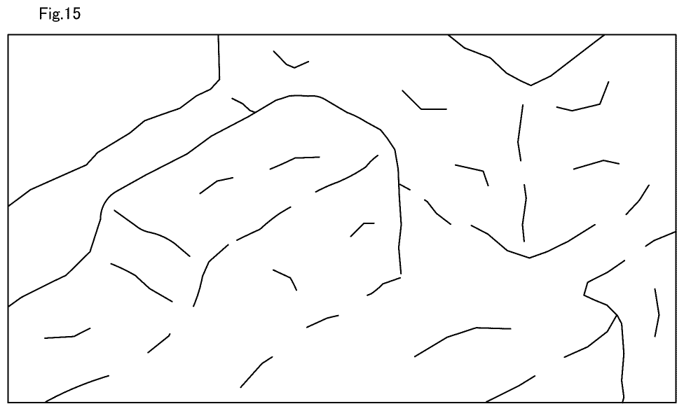

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the present embodiment, in practice, a voxel object is generated (e.g., based on voxel data) by such a rule that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

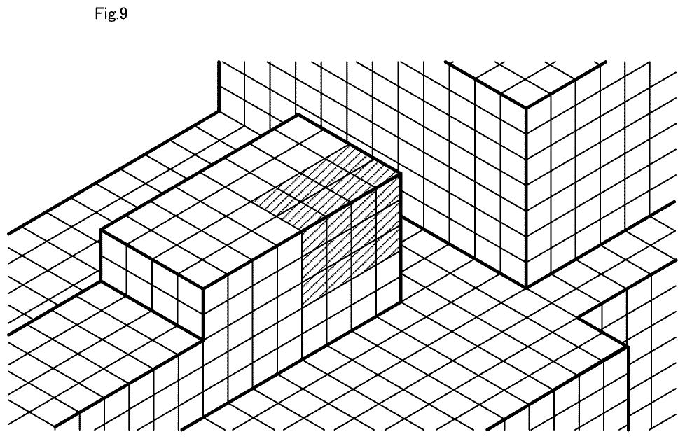

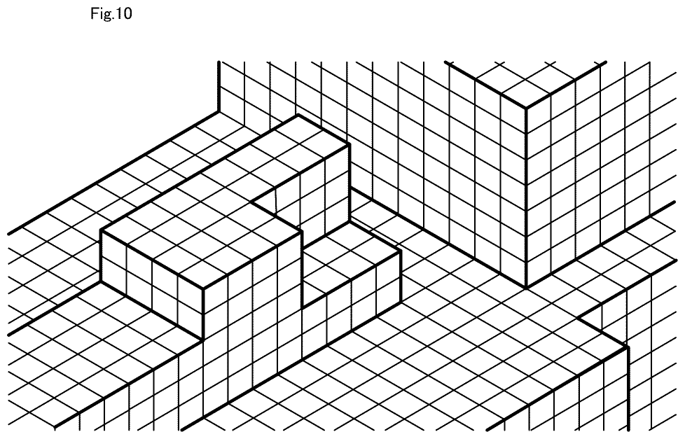

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

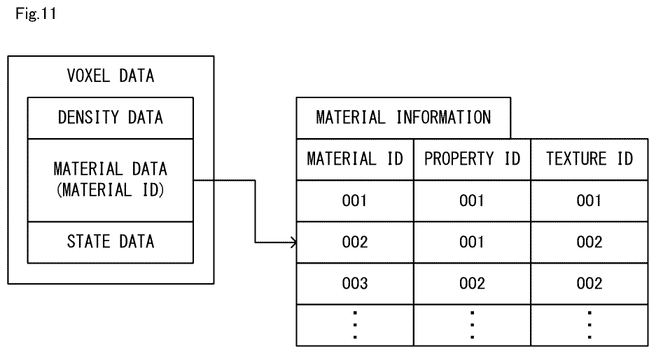

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents the density, which is an index used to define the shape of a voxel object in the voxel corresponding to the voxel data (specifically, the shape defined by the mesh to be described below). As will be described in detail below, the position and the shape of the surface of the voxel object (e.g., the mesh to be described below) are determined based on this density. In other words, in the present embodiment, this density is used to generate a mesh that defines the surface of the voxel object.

In the present embodiment, the density can take an integer value in the range from the lower limit value (e.g., 0) to the upper limit value (e.g., 255). In the present embodiment, the game system 1 determines the shape of a voxel object based on the density such that the proportion of the volume to be occupied by the voxel object in a voxel tends to be higher when the density value set for the voxel is higher and that the proportion tends to be lower when the density value is lower. Thus, the density is an index that affects the proportion of the volume to be occupied by the voxel object in the voxel. The density can also be said to be an index that represents the degree to which an object is included in the region defined by each voxel. For example, if the density is 0, there is no voxel object in the voxel, if the density is 255, the inside of the voxel is entirely the voxel object, and if the density is between 0 and 255, the inside of the voxel is occupied by the voxel object to the proportion that is determined based on the density value. Then, the shape of the mesh, e.g., the shape of the voxel object, can determined based on the density. Note however that the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

In other embodiments, the density may indicate either a state in which the voxel object occupies the entirety of the region within the voxel or a state in which no voxel object is included in the region within the voxel. For example, the density data may be data that can take only 0 or 1.

As shown in FIG. 11, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

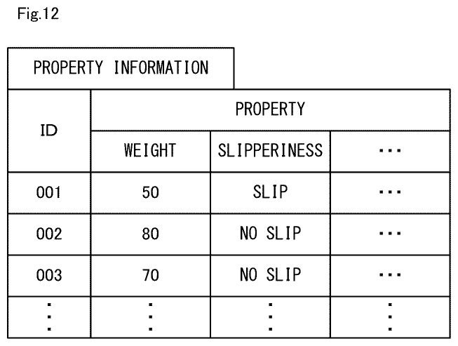

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

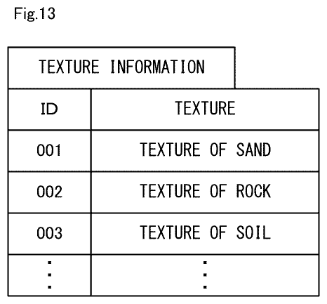

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

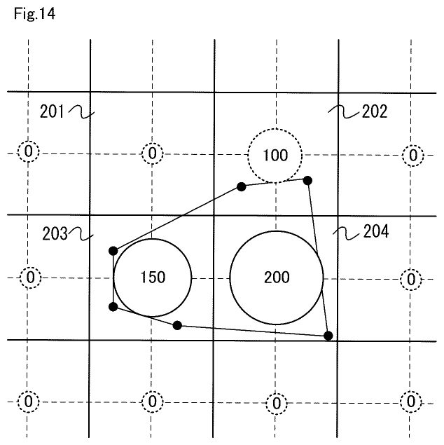

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for the voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is less than the reference value, and voxels 203 and 204 have densities of 150 and 200, which are greater than the reference value (e.g., 128). In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference value, the voxel 202 is treated as being outside the voxel object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference value are treated as being outside the voxel object in the present embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### [2-3. Primary Voxel and Sub-Voxel]

In the present embodiment, in addition to the terrain object described above, other objects that are different from the terrain object may be generated as voxel objects. The other objects are, for example, objects representing ice, objects representing rocks, enemy objects, etc., as will be described below.

Here, in the present embodiment, the shape of the other objects is defined by voxel data related to voxels that are different from the terrain object. Hereinafter, the voxel space related to the terrain object is called “primary voxel space”, voxels in the primary voxel space are called “primary voxels”, and voxel data set in the primary voxels are called “primary voxel data”. On the other hand, the voxel space related to the other objects is called “sub-voxel space”, voxels in the sub-voxel space are called “sub-voxels”, and the voxel data set in the sub-voxels are called “sub-voxel data”. In the present embodiment, the shape of the terrain object is defined by primary voxel data, and the shapes of the other objects are specified by sub-voxel data. In the present embodiment, a voxel object whose shape is defined by primary voxel data is called “primary voxel object”, and a voxel object whose shape is defined by sub-voxel data is called “sub-voxel object”.

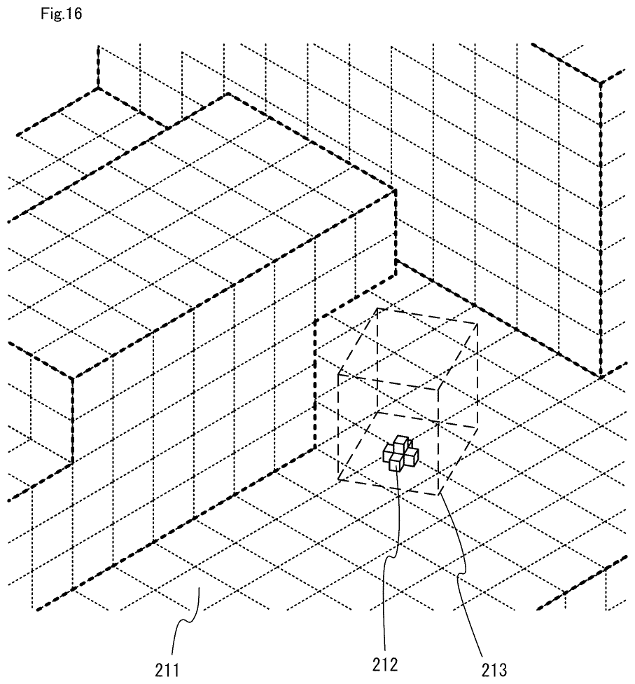

FIG. 16 is a view showing an example of a primary voxel object and a sub-voxel object. Note that for the purpose of showing the difference between a primary voxel and a sub-voxel in an easy-to-understand manner, FIG. 16 shows a voxel object (e.g., a terrain object 211 and a rock object 212) for which meshes are generated by the same rules that are used to generate meshes for the terrain object shown in FIG. 8. That is, it is assumed that the mesh for the voxel object shown in FIG. 16 is generated according to the rule that “if the density set for a voxel is greater than a predetermined value, a cube is arranged at the position of the voxel, and if the density is less than or equal to the predetermined value, nothing is arranged at the position of the voxel”. Note that in FIG. 16, for the purpose of making the drawing easier to read, the terrain object 211 is indicated by dotted lines, the rock object 212 is indicated by solid lines, and an area 213 of the sub-voxel space is indicated by broken lines.

The shape of the terrain object 211 is defined by primary voxel data. Note that in the present embodiment, it is assumed that the primary voxel space is set across the entire game space (therefore, the range of the primary voxel space is not shown in FIG. 16).

On the other hand, the shape of the rock object 212 is defined by sub-voxel data. Here, in the present embodiment, the sub-voxel space is set in a part of the game space (which can be said to be a part of the primary voxel space). Note that in the example shown in FIG. 16, the area 213 indicated by the broken line is the area where the sub-voxel space is set. The shape of the rock object 212 is defined by sub-voxel data set for each sub-voxel set in the sub-voxel space. The rock object 212 is arranged within the range of the sub-voxel space.

The length of one side of a sub-voxel may be set to be different from or the same as the length of one side of a primary voxel. Note that as shown in FIG. 16, for example, by setting a sub-voxel space in which voxels of which the length of one side is shorter than that of primary voxels are defined as sub-voxels, the shape of a sub-voxel object based on the sub-voxel data can be expressed more finely than a terrain object based on primary voxel data.

In the present embodiment, the game system 1 sets the directions of the coordinate axes in the sub-voxel space (e.g., the directions of the sides of a sub-voxel) independently of the directions of the coordinate axes in the primary voxel space (e.g., the directions of the sides of a primary voxel). For example, in the example shown in FIG. 16, the directions of the coordinate axes in the sub-voxel space are different from those in the primary voxel space. This makes it easier to arrange sub-voxel objects in any orientation in the game space. For example, it becomes easier to arrange sub-voxel objects so as to extend in different directions from the coordinate axes in the primary voxel space. It is also easier to move (e.g., rotate) sub-voxel objects independently of the terrain object.

Note that the game system 1 can change the position of the sub-voxel object (more precisely, its position in the game space) by changing the position of the sub-voxel space in the game space. The game system 1 can change the posture (more precisely, the posture in the game space) of the sub-voxel object by changing the posture of the sub-voxel space with respect to the game space.

In the present embodiment, where a plurality of sub-voxel objects are generated, the game system 1 sets a sub-voxel space for each sub-voxel object. This allows the position and posture of each sub-voxel space in the game space to be set for each sub-voxel space. It makes it easier to generate a plurality of sub-voxel objects each having a different shape (e.g., a plurality of sub-voxel objects having shapes that extend in different directions from each other). Note that the sub-voxel spaces may be arranged so that a part of a sub-voxel space overlaps with a part of another sub-voxel space. In other embodiments, a plurality of sub-voxel objects may be set in one sub-voxel space.

Note that the method for generating a mesh for a sub-voxel object based on sub-voxel data may be the same as or different from the method for generating a mesh for the terrain object based on primary voxel data.

### [2-4. Deformation Process Using Particle Data]

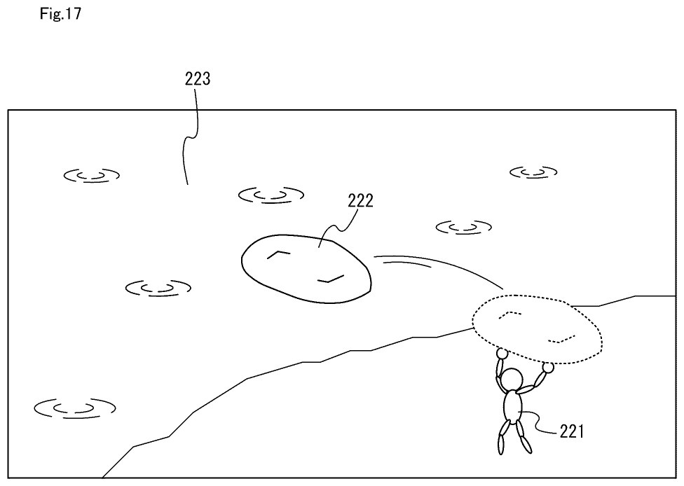

Next, the process of deforming a voxel object using particle data will be described. Particle data is data that represents a plurality of particles corresponding to an object (hereinafter referred to as a “group of particles”). Specifically, particle data includes data representing the position of each particle. In the present embodiment, the game system 1 can naturally express a voxel object deforming (e.g., a voxel object deforming by melting) by using particle data. Referring to FIG. 17 to FIG. 24, an example where an ice object deforms by melting will be described.

FIG. 17 shows an example of a game space in which an ice object is arranged. The example shown in FIG. 17 shows a player object 221 throwing an ice object (e.g., an object whose material is set to ice) 222 toward a lava terrain object (e.g., a terrain object whose material is set to lava) 223. Note that in the example shown in FIG. 17, the lava terrain object 223 is a primary voxel object and the ice object 222 is a sub-voxel object.

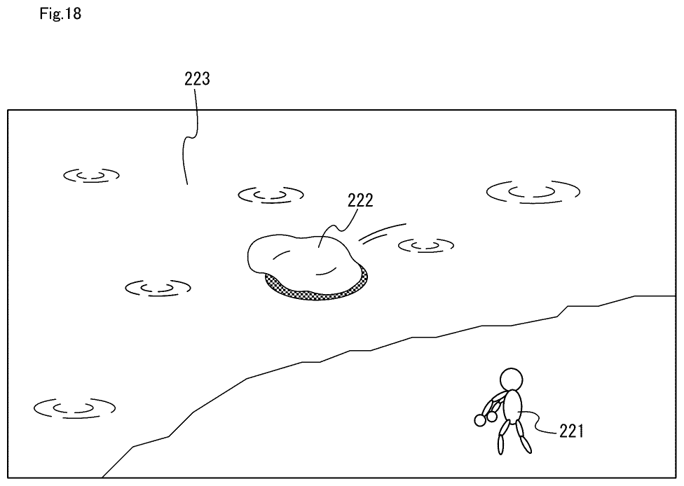

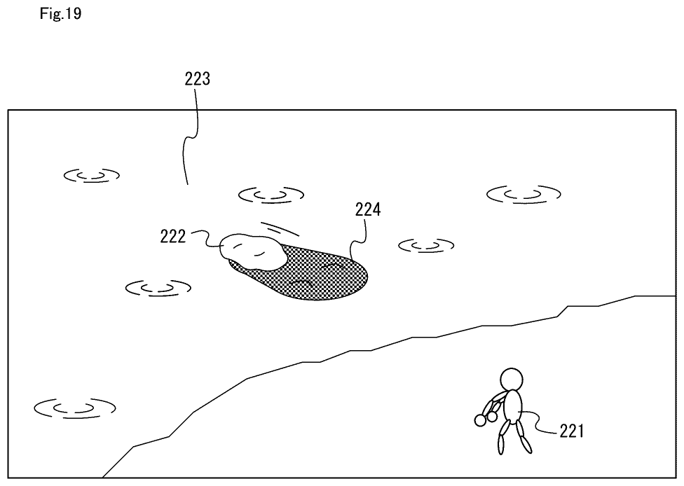

FIG. 18 is a view showing an example of a state where the ice object 222 contacts the lava terrain object 223 from the state shown in FIG. 17. FIG. 19 is a view showing an example of a state where the ice object deforms from the state shown in FIG. 18. As shown in FIG. 18 and FIG. 19, in the present embodiment, the ice object 222 deforms upon contacting the lava terrain object 223, and further, the ice object 222 gradually becomes smaller. Thus, it is possible to express the ice object 222 melting by the lava terrain object 223. When deforming the ice object 222 in such a manner, the game system 1 executes the deformation process using particle data.

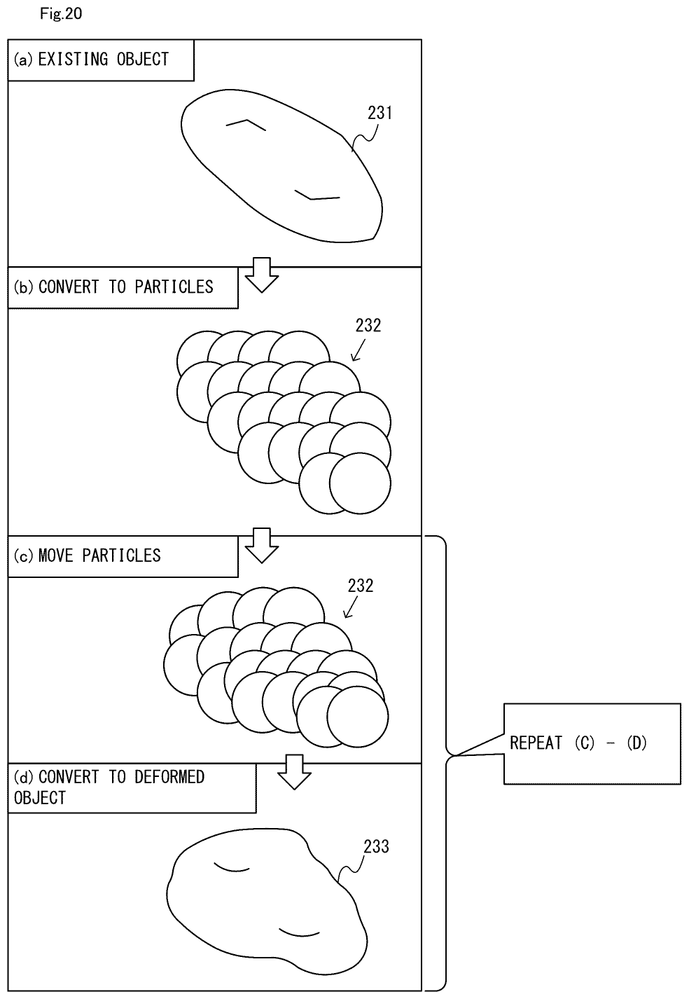

FIG. 20 is a view showing an example of a process for deforming an object using particle data. The object in the state (a) of FIG. 20 is an undeformed object 231 using particle data (e.g., the ice object 222). Hereafter, the undeformed object 231 will be referred to as the “existing object”.

In the present embodiment, when the generation condition is satisfied for the existing object, the game system 1 generates particle data based on the existing object. In the example shown in FIG. 20, the game system 1 generates particle data representing the positions of a plurality of particles (e.g., a group of particles 232 shown in (b) of FIG. 20), which are arranged so as to correspond to the shape of an existing object 231. Note that “a plurality of particles corresponding to the shape of an object” can include that the shape that is formed by the plurality of particles as a whole generally coincides with the shape of the object, and means that the shape formed by the plurality of particles do not need to coincide strictly with the shape of the object. The process of generating particle data can be said to be the process of converting the existing object into a plurality of particles that correspond to the shape of the existing object.

Note that there is no limitation on the content of the generation condition. For example, the generation condition for the ice object is that it contacts an object of a specific material (specifically, a lava terrain object). Thus, in the present embodiment, the game system 1 generates particle data corresponding to an existing object in response to the existing object contacting an object different from the existing object. Then, the processing load of the game system 1 can be reduced because particle data is not generated during the period before contact, when there is no need to deform the existing object.

In the present embodiment, the game system 1 can generate the particle data corresponding to the existing object at least on the condition that the material set for the existing object and the material set for the other object are in a predetermined combination (e.g., the material of the existing object is ice and the material of the other object is lava). Then, it is possible to express the existing object deforming in response to contacting a particular object.

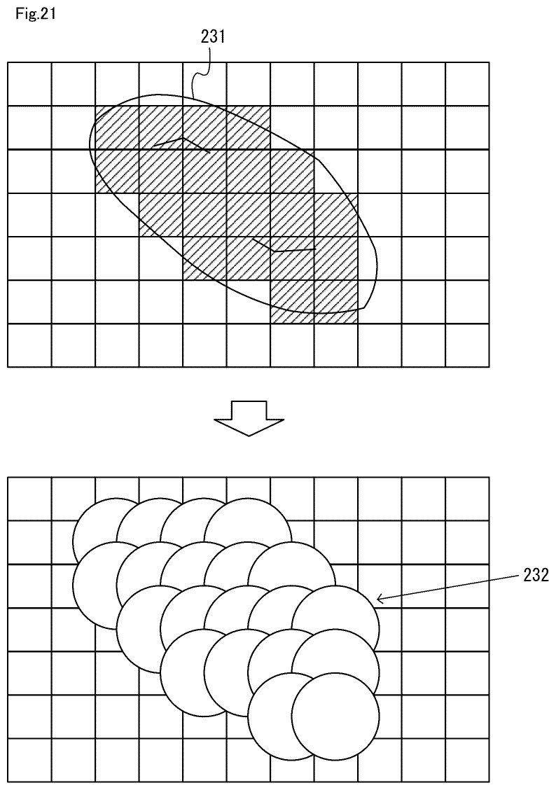

FIG. 21 is a view showing an example of setting a plurality of particles based on the existing object. In the present embodiment, the game system 1 sets rectangular parallelopiped (more specifically, cubic) particle regions arranged in a grid in the game space and sets particles using the particle regions (see FIG. 21). Note that the grid shown in FIG. 21 is the grid of particle regions. The game system 1 arranges particles in one or more particle regions by determining, for each particle region, whether or not to arrange a particle in the particle region. Note that FIG. 21 represents different elements (e.g., particle regions, existing objects and particles) in two dimensions for the purpose of making the drawing easier to read and understand, but these elements are arranged in a three-dimensional space in practice.

The determination of whether or not to arrange a particle in a particle region is made based on whether or not the existing object is present in the particle region. That is, if the existing object is present in a particle region, a particle is arranged in the particle region, and if the existing object is absent in a particle region, no particle is arranged in the particle region. In the present embodiment, the determination of whether or not the existing object is present in a particle region is made based on voxel data of the existing object. Specifically, if the existing object is present in a voxel that overlaps with a particle region (e.g., the density of the voxel is equal to or greater than the reference value), the game system 1 determines that the existing object is present in the particle region. On the other hand, if the existing object is absent in a voxel that overlaps with a particle region (e.g., the density of the voxel is less than the reference value), the game system 1 determines that the existing object is absent in the particle region.

Note that there is no limitation on the specific method for determining whether or not the existing object is present in a particle region, and the method is not limited to the above. For example, in other embodiments, the game system 1 may make the determination based on the mesh of the existing object, instead of voxel data of the existing object. Specifically, the game system 1 may determine that the existing object is present in a particle region if the mesh of the existing object is present in the particle region or if the particle region is an internal region of the existing object (e.g., an internal region surrounded by the mesh).

In the example shown in FIG. 21, the existing object 231 is determined to be present for particle regions that are hatched. Then, the game system 1 arranges particles in the hatched particle regions (e.g., generates particle data indicating that particles are arranged in the hatched particle regions). Thus, the group of particles 232 is set corresponding to the shape of the existing object 231 (see FIG. 21). Note that in the present embodiment, while it is determined that the existing object 231 is present in a voxel when the density of the voxel is equal to or greater than the reference value, a mesh for the existing object 231 can be generated also for voxels of which the density is less than the reference value (and 1 or more). Therefore, in the example shown in FIG. 21, a mesh for the existing object 231 may be present in particle regions other than the hatched particle regions, as shown in the figure.

As described above, in the present embodiment, the game system 1 generates particle data based on whether or not at least a part of the existing object is present in each of a plurality of unit regions (e.g., particle regions) that are obtained by partitioning the region including the existing object in the virtual space into a grid. Then, it is possible to generate, with a small amount of calculation, particle data representing a group of particles arranged according to the shape of the existing object.

Note that there is no limitation on how the particle regions are set in the game space. That is, there is no limitation on the size of a particle region and the orientation of each side of a particle region. In the present embodiment, the length of one side of a particle region is equal to the length of one side of a voxel corresponding to the voxel data generated based on particle data (e.g., voxel data of a voxel object 233 shown in FIG. 20). Then, it is possible to generate a voxel object that sufficiently shows the shape represented by a group of particles, and also to reduce the processing load of the game system 1 by reducing the number of particles. Note that the length of one side of a particle region can be said to be equal to the length of one side of a voxel related to the existing object. Then, it is possible to set a group of particles that sufficiently shows the shape of the existing object.

In the present embodiment, the orientation of each side of a particle region is set to be the same as the orientation of each side of a voxel corresponding to the voxel data generated based on the particle data. Then, the orientation of the grid of the particle region can be made to coincide with the orientation of the sub-voxel related to the voxel object generated based on the particle data, thereby reducing the load of the process of generating the voxel object.

Note that the game system 1 does not need to set particle regions across the entire game space, but only needs to set particle regions in a range that includes the existing object. For example, particle regions are set in the sub-voxel space related to the existing object. Then, particle regions can be set efficiently, and it is possible to reduce the processing load of the game system 1.

In the present embodiment, particles are spherical, and the radius thereof is equal to the length of one side of a voxel corresponding to voxel data generated based on particle data (it can also be said to be the same as the length of one side of a particle region) (see FIG. 21). Then, it is possible to generate a voxel object that sufficiently shows the shape represented by a group of particles. Note however that there is no limitation on the size of a particle, which may be shorter or longer than the length of one side of a voxel related to the voxel object. Note that the radius of a particle can also be said to be equal to the length of one side of a voxel related to the existing object. Then, it is possible to set a group of particles that sufficiently shows the shape of the existing object.

In the present embodiment, the size of each particle generated is assumed to be constant, but in other embodiments, the size of each particle does not need to be constant. For example, the game system 1 may vary the size of a particle arranged in a particle region in accordance with the percentage of the volume occupied by the existing object in the particle region (specifically, the larger the percentage, the larger the size of the particle). Then, particle data may include, for each particle, data representing the position of the particle and data representing the size of the particle. The particle data may further include data representing the travelling speed of each particle.

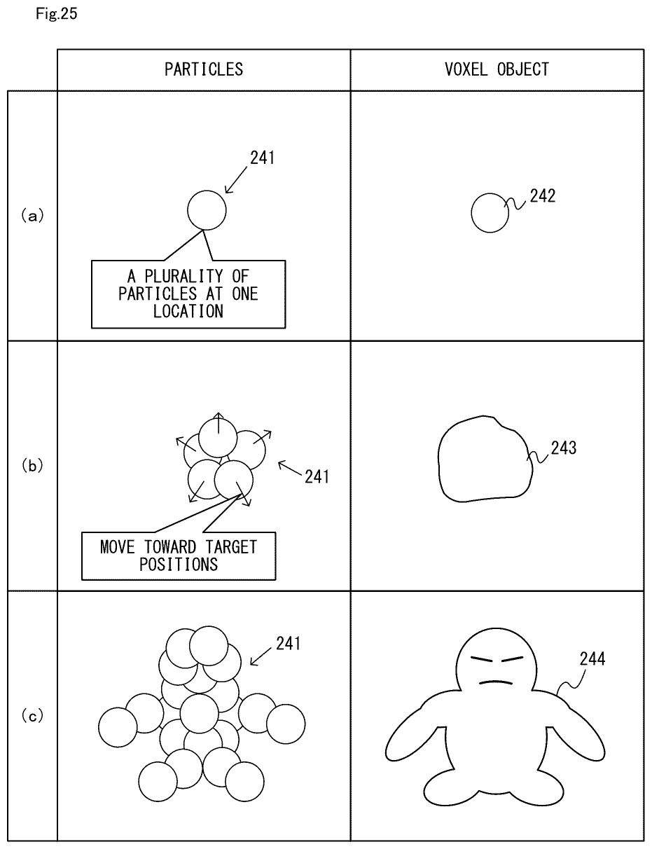

After generating particle data, the game system 1 moves the group of particles 232 represented by the particle data for each particle in order to generate a voxel object that is obtained by deforming the existing object ((c) shown in FIG. 20). That is, the game system 1 updates the particle data so as to represent the position of each particle after the movement. In the present embodiment, the game system 1 repeatedly executes the moving process at a rate of once per frame time. Here, there is no limitation on the rules for moving particles. For example, when expressing the ice object 222 melting, the particles may be moved according to the physical laws (e.g., gravity or collisions with other objects) that are applied in the game space. Note that conventional fluid simulation methods may be used to move the particles. Although the details will be described below, the game system 1 may set target positions for the particles and move the particles toward the target positions (see FIG. 25 to be discussed below).

After moving the group of particles 232, the game system 1 generates a voxel object (referred to as “deformed object”) 233 that represents a shape that is obtained by deforming the existing object based on the group of particles 232 having been moved ((d) shown in FIG. 20). That is, the game system 1 generates voxel data based on the particle data representing the group of particles having been moved, and generates a mesh for the deformed object 233 based on the voxel data generated. The process of generating a mesh as described above can be said to be the process of converting the group of particles 232 into the deformed object 233.

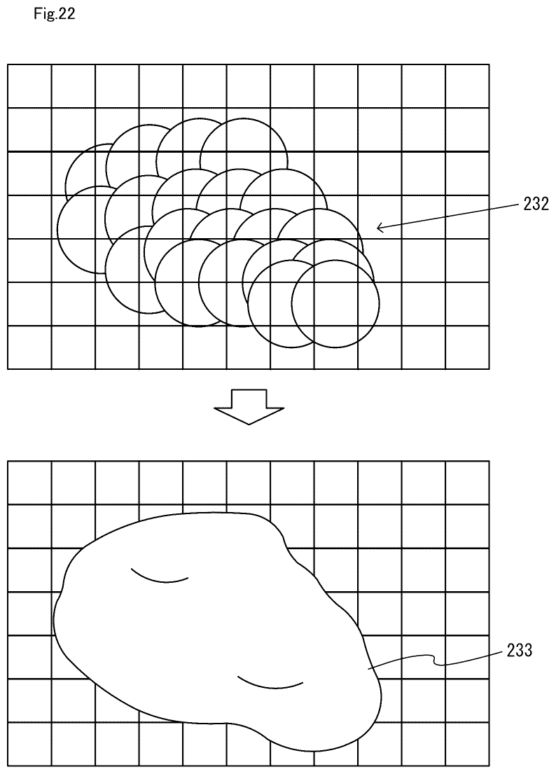

FIG. 22 is a view showing an example of generating the deformed object 233 from the group of particles 232. Note that the grid shown in FIG. 22 is a grid of sub-voxels related to the deformed object 233. The game system 1 generates voxel data for the deformed object 233 by setting the density for each sub-voxel based on the group of particles 232. Note that in FIG. 22, as in FIG. 21, elements (e.g., group of particles, sub-voxels and voxel objects) are represented in two dimensions for the purpose of making the drawing easier to read and making the discussion easier to understand, but these elements are arranged in a three-dimensional space in practice.

The density of a sub-voxel is set based on whether or not a particle is present in the sub-voxel. In the present embodiment, the game system 1 sets the density of the sub-voxel to the upper limit value (e.g., 255) if at least one particle is present in the sub-voxel, and sets the density of the sub-voxel to the lower limit value (e.g., 0) if a particle is absent in the sub-voxel. Then, voxel data can be generated by a simple calculation, and it is possible to reduce the processing load of the game system 1.

Note that there is no limitation on the specific method for generating voxel data based on particle data, and the method is not limited to the above. For example, in other embodiments, the game system 1 may set the density of a sub-voxel based on the number of particles that are present in the sub-voxel (specifically, the greater the number of particles, the greater the density). For example, the game system 1 may set the density of a sub-voxel based on the distance from the center of the particle to the sub-voxel (specifically, the longer the distance from the center of the particle to the sub-voxel, the smaller the density).

The game system 1 generates a mesh for the deformed object 233 based on the voxel data generated. Note that there is no limitation on the specific method for generating a mesh based on voxel data. The game system 1 may generate a mesh for the deformed object 233 by a method that is the same as or different from the method for generating a mesh for an object other than the deformed object 233 (e.g., the terrain object and the existing object).

In the example shown in FIG. 22, as the mesh for the deformed object 233 is generated by the method described above, the mesh is generated so as to generally cover the group of particles 232. This results in the generation of the deformed object 233 whose shape corresponds to the general shape of the group of particles 232.

The game system 1 changes the shape of the deformed object over time by repeatedly executing the movement of particles ((c) shown in FIG. 20) and the generation of the deformed object ((d) shown in FIG. 20). Thus, it is possible to express an ice object melting gradually, for example.

In the present embodiment, when moving particles again after generating the deformed object, the game system 1 calculates the positions of the particles having been moved by moving particles from their previous positions without generating particles from the deformed object (e.g., without converting the deformed object into a group of particles). That is, the game system 1 calculates the value of the current particle data (e.g., the value representing the new positions of the particles) using the previously updated particle data, without using voxel data that is generated based on the previously updated particle data (e.g., voxel data of the deformed object). This is because if the deformed object is converted into a group of particles, this conversion may cause errors in the positions of the particles, and the positions of the particles having been moved may not be calculated precisely. In contrast, in the present embodiment, by using the previously updated particle data, it is possible to precisely calculate the positions of the particles having been moved. Note that in the other embodiments, the game system 1 may convert the deformed object into a group of particles, and calculate particle data representing the positions of the particles having been moved using particle data representing the converted group of particles.

In the present embodiment, the deformed object 233 generated based on the particle data is a sub-voxel object. Therefore, if a particle is arranged outside of the sub-voxel space related to the deformed object 233, the particle will not be showed in the shape of the deformed object 233. As a result, the shape of the deformed object 233 may not correspond to the shape of the group of particles 232. Therefore, in the present embodiment, the game system 1 executes the processes of moving the sub-voxel space and modifying the positions of the particles. The moving process and the modification process will be described below.

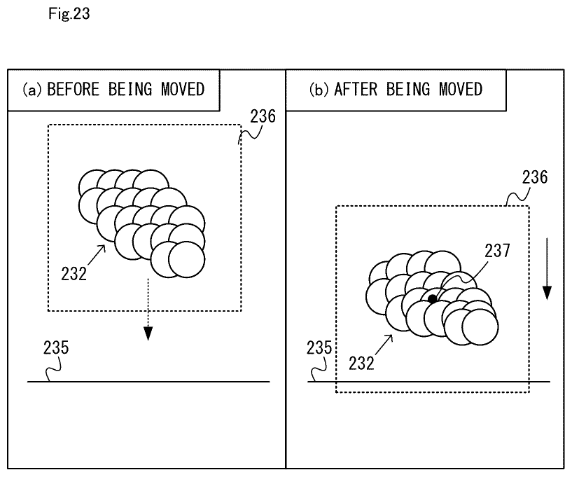

FIG. 23 shows an example of the process of moving the sub-voxel space. In the example shown in FIG. 23, the group of particles 232 is deformed from a state where they are at a position away from a ground 235 (the state (a) in FIG. 23) to a state where the group of particles 232 is deformed while moving closer to the ground 235 (the state (b) in FIG. 23).

In the example shown in FIG. 23, if a sub-voxel space 236 does not move from the unmoved state, some of the particles of the group of particles 232 having been moved will be outside the sub-voxel space 236 as a result of the movement of the group of particles 232. As a result, the deformed object having been moved will have a shape that does not show those particles.

Therefore, in the present embodiment, the game system 1 updates the range (can be referred to also as the position) of the sub-voxel space of the deformed object in response to updating the position of the group of particles 232. In the present embodiment, the game system 1 calculates a center of gravity position 237 of each particle having been moved and moves the sub-voxel space so that the center of gravity position 237 is the center position of the sub-voxel space (see arrow shown in FIG. 23). Note that in other embodiments, the game system 1 may identify particles of the group of particles 232 that are located at the front, back, left, right, upper and lower edges and determine the position of the updated sub-voxel space so that the center position of the sub-voxel space is located at the center position of each of the identified particles. As described above, in the present embodiment, the game system 1 updates the range of the voxel space, in which voxels related to the voxel data of the deformed object are set, based on the updated particle data. This reduces the possibility that the particles having been moved are located outside the sub-voxel space.

Note that the specific method for updating the position of the sub-voxel space is not limited to the above. In the present embodiment, the game system 1 changes the range of the sub-voxel space by moving the center position without changing the size of the sub-voxel space, but in other embodiments, the game system 1 may change the range of the sub-voxel space by changing the size of the sub-voxel space.

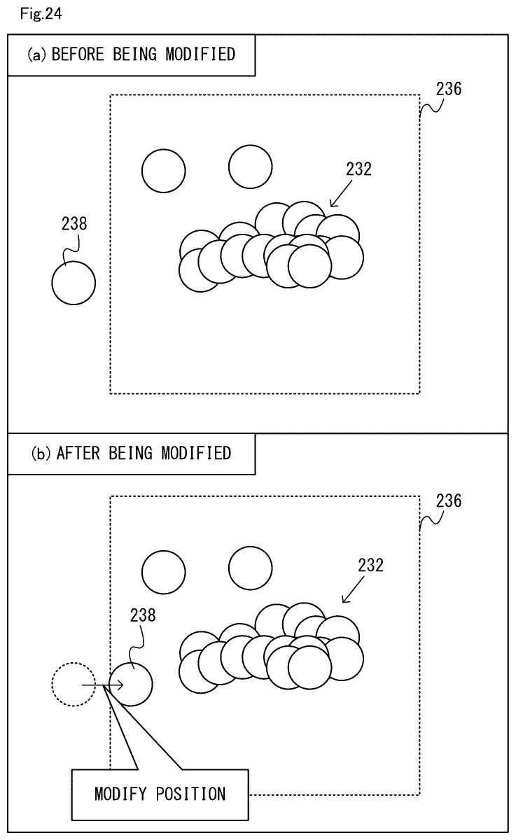

FIG. 24 is a view showing an example of the process for modifying the positions of the particles. The example shown in FIG. 24 shows how the particle 238 is located outside of the sub-voxel space 236 as a result of the movement of the group of particles 232 (see (a) in FIG. 24). Note that in the example shown in FIG. 24, some particles, including the particle 238, are arranged at a position away from other particles. Such a state may occur when some of the particles are scattered as a result of the group of particles 232 contacting another object, for example. The position of the sub-voxel space 236 shown in FIG. 24 is the position of the sub-voxel space after it has been moved by the process of moving the sub-voxel space described above.

If the particle 238 is located outside the sub-voxel space 236 as described above, the game system 1 modifies the position of the particle 238 so that the particle 238 is located within the sub-voxel space 236 (see (b) in FIG. 24). Thus, the game system 1 controls the positions of a plurality of particles so that they are located within the voxel space where the voxels related to the voxel data of the deformed object are set. Thus, it is possible to further reduce the possibility that particles may be located outside the sub-voxel space.

Note that there is no limitation on the specific method for modifying the positions of the particles. For example, in the present embodiment, the game system 1 modifies the position of a particle outside the sub-voxel space to a position within the sub-voxel space so that the amount of movement for modification is minimized. That is, the modified position of a particle is set to a position at which one of the normals on the outer surface of the sub-voxel space that passes through the position of the particle before being modified intersects with the outer surface.

In the present embodiment, when deforming an object using particle data, the game system 1 makes particles disappear in response to satisfaction of the disappearance condition. For example, if the existing object is an ice object described above, the disappearance condition includes a condition that “the particle has contacted objects of the specific material (e.g., an object pertaining to the generation condition, specifically, a lava terrain object) a predetermined number of times”. The game system 1 determines for each particle whether or not the disappearance condition is satisfied. Specifically, the game system 1 determines whether or not a particle has contacted an object of a specific material each time the particle is moved, and when the number of times the particle has contacted the object reaches the predetermined number, the particle is made to disappear. If the particle disappears as described above, the deformed object is generated based on the remaining particles. Thus, the deformed object gradually becomes smaller as the particle disappears (see FIG. 19).

As described above, in the present embodiment, the game system 1 updates the particle data so that at least some of the plurality of particles disappear in response to satisfaction of the disappearance condition. Then, the existing object (can be referred to also as the deformed object) can be deformed while becoming smaller, and it is possible to express an object melting and becomes smaller.

Note that there is no limitation on the content of the disappearance condition, which is not limited to the above. For example, the disappearance condition may be that a time limit has elapsed since the generation of the particle. Then, the deformed object corresponding to the existing object will disappear when the time limit has elapsed since the generation of the deformed object. Then, it is possible to prevent the process for moving particles and the process for generating the deformed object from increasing with the deformed object not disappearing and continuing to remain. Therefore, it is possible to reduce the processing load of the game system 1.

In other embodiments, the disappearance condition may be being struck by another object (e.g., the player object). For example, when the player object strikes the deformed object, the game system 1 may cause particles within a range defined with respect to the position where the strike has been made disappear. Then, it is possible to express the deformed object disappearing by being struck.

Note that in the present embodiment, the game system 1 defines the disappearance condition to be satisfaction of either: the particle has contacted an object of the specific material a predetermined number of times; or a time limit has elapsed since the generation of the particle.

In other embodiments, the game system 1 does not need to make the particle disappear. That is, when the game system 1 deforms an object using particles, it is not necessary to deform said object so that it becomes smaller.

In other embodiments, the game system 1 may change the material of the deformed object from the material of the existing object, instead of (or in addition to) making particles disappear. For example, where the existing object is an iron object, the game system 1 may, in response to the existing object contacting a lava object, deform the existing object using particles and change the material of the existing object from “iron”, which has a property of being hard, to “molten iron”, which has a property of being soft.

Although the description above is directed to an example of expressing the existing object deforming by melting (and becomes smaller), it is possible to express an object deforming in various manners, not limited to melting, by using particle data. For example, as will be shown below, it is possible to express an object growing larger by using particle data.

FIG. 25 is a view showing an example of how a voxel object grows larger. FIG. 25 shows how a small spherical object in the initial state shown in (a) grows larger in the state shown in (b) and takes the shape of an enemy object in the state shown in (c). It is possible to use particle data also when realizing such an expression.

In the example shown in FIG. 25, an existing object 242 is a small spherical object. When the generation condition is satisfied for the existing object 242, the game system 1 generates particle data and executes the deformation process using particle data. Note that the generation condition in this example is a predetermined game condition (e.g., satisfaction of the condition for an enemy object to appear). Thus, the generation condition is not limited to the existing object contacting another object, but may be any other condition.

If the generation condition is satisfied, the game system 1 first arranges a plurality of particles (a group of particles 241 shown in FIG. 25) so as to correspond to the shape of the existing object 242. Note that, depending on the size of the existing object 242, it may be the case that the number of particles sufficient to correspond to the shape of the existing object 242 is one. Even in such a case, the game system 1 arranges a group of particles 241 consisting of a predetermined number of particles. In such a case, particles are arranged to be redundant with each other (e.g., particles are arranged at the same position).

Once particles are arranged, the game system 1 moves the particles of the group of particles 241 and generates a deformed object 243 based on the particles having been moved, as in the example described above (state (b) shown in FIG. 25). Here, in the example shown in FIG. 25, the game system 1 sets a target position for each particle. The target position is the position to which a particle should move eventually, and in the example shown in FIG. 25, it is the position at which the group of particles 241 corresponds to the shape of the enemy object (e.g., a deformed object 244). In the present embodiment, the game system 1 stores target position data representing the target position for each particle. The target position data can be said to be data representing the position of each particle having been changed over time.

The game system 1 moves the particles toward their target positions. In one iteration of the moving process (e.g., the process of moving the particles for one frame), the game system 1 updates the particle data so that each of the particles moves to a destination position that is set for the particle in the group of particles 241. Then, it is possible to easily move particles to desired positions, making it easy to perform the process of deforming an object into a desired shape.

The destination position is, for example, the position that is arrived at by moving a particle from the current position toward the target position by the amount of movement of the particle in one iteration of the moving process. Here, there is no limitation on the amount of movement. For example, the game system 1 may set an amount of time (referred to as the “movement completion time”) to be taken until the particle's movement is complete, and in one iteration of the moving process, the particle may be moved by a distance that is obtained by dividing the distance from the position of the particle in the initial state to the target position by the movement completion time. In the other embodiments, the game system 1 may pre-set the amount of movement for each particle. The amount of movement does not need to be constant for each moving process of one frame, and may be a different amount for each iteration of the moving process.

The game system 1 moves each particle of the group of particles 241 until it reaches its target position. When the particles have reached their target positions (the state (c) in FIG. 25), the deformed object 244 generated based on the group of particles 241 takes the shape of the completed enemy object (or a shape that generally coincides with the shape). Thus, by the deformation process using particles, it is possible to deform a small object into a large enemy object.

As described above, the game system 1 sets the destination position based on the target position, and updates the particle data until the particles reach their respective target positions. Then, it is possible to move the particles to any positions and to deform the object into a desired shape.

In the present embodiment, at a switching timing after the particles have moved to their respective target positions, the game system 1 ends the generation of the deformed object 244 based on the particle data. Here, the game system 1 stores in advance post-change data that represents the shape of the object (specifically, the enemy object) after the existing object has been changed. The shape represented by the post-change data is, for example, a shape that generally coincides with the shape formed by the group of particles when the particles have reached the target positions. The post-change data may be any data that can generate a mesh of the object after the change, and it may be voxel data or bone data. The object after the change after the switching timing may or may not be a voxel object.

At the switching timing, the game system 1 starts generating the object after the change based on the post-change data, instead of generating the deformed object 244 based on the particle data. That is, the game system 1 generates a mesh for a voxel object based on voxel data based on particle data at least until the plurality of particles reach their target positions. Then, at the switching timing after the plurality of particles have reached their target positions, the game system 1 ends the generation of the mesh based on voxel data based on particle data and generates the mesh based on the post-change data. Then, even if the shape of the object after the change cannot be reproduced precisely by particle data, the shape can be adjusted to a shape of a good precision after the switching timing. Since the game system 1 does not need to execute the process of generating a voxel object based on particle data after the switching timing, it is possible to reduce the processing load of the game system 1.

Note that the switching timing may be any timing after the particles have moved to their respective target positions. For example, the switching timing may be a timing immediately after the particles have moved to their respective target positions, or may be a timing after a predetermined amount of time has elapsed since when the particles have moved to their respective target positions.

In the present embodiment, the deformed object may be one that influences another object in response to contacting with the other object. For example, in the example shown in FIG. 19, when the ice object 222 contacts with the lava terrain object 223, the game system 1 changes the contacted portion of the lava terrain object 223 into a rock terrain object 224 (e.g., rock formed by lava having been solidified). This change can be made by changing material data included in voxel data. Thus, the deformed object may change the material (specifically, the appearance and/or properties) of another contacted object.

The deformed object may be one that causes another contacted object to disappear. That is, when the deformed object contacts another object, the game system 1 may cause the contacted portion of the object to disappear.

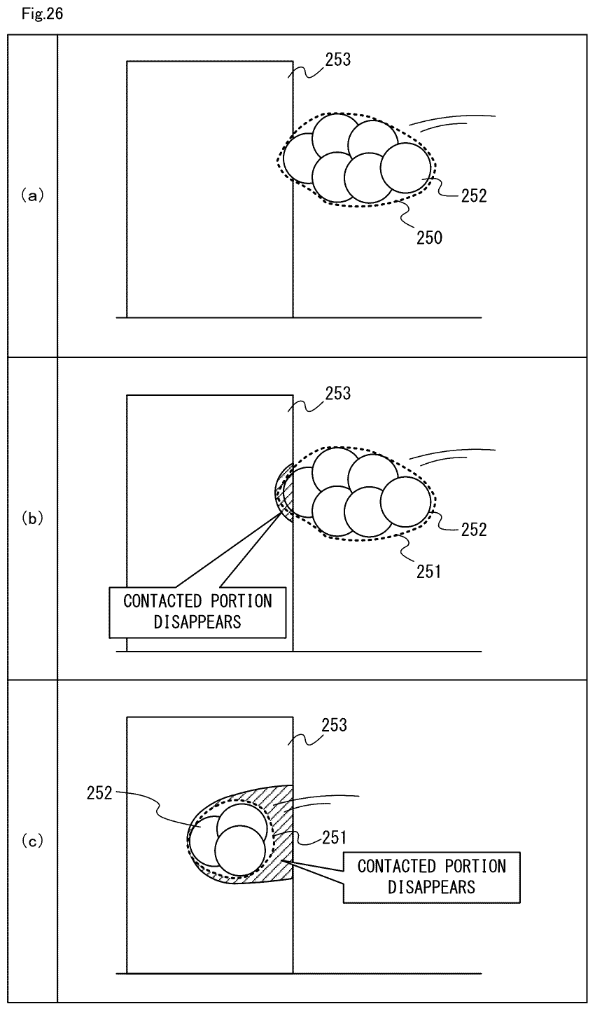

FIG. 26 is a view showing an example of how another object is made to disappear by the deformed object. In FIG. 26, when a deformed object 251 moving in the game space contacts a terrain object 253, the deformed object 251 itself deforms by melting while causing the terrain object 253 to disappear.

In the example shown in FIG. 26, when an existing object 250 contacts the terrain object 253, the game system 1 generates a group of particles 252 corresponding to the shape of the existing object 250 ((a) in FIG. 26). Note that in this example, the generation condition for generating particle data is that the existing object 250 has contacted the terrain object 253.

When the group of particles 252 is generated, the game system 1 determines the contact between the particles and the terrain object 253, and causes a portion of the terrain object 253 that has contacted a particle to disappear ((b) in FIG. 26). Where the terrain object 253 is a voxel object, it is possible to change the shape of the terrain object 253 as if the portion had disappeared by updating the voxel data. If the disappearance condition is satisfied in response to contact between the particle and the terrain object 253, the game system 1 causes the particle for which the disappearance condition is satisfied to disappear.

As described above, the game system 1 repeats the movement of each particle in the group of particles 252 and the generation of the deformed object 251. In the example shown in FIG. 26, as the deformed object 251 moves, the group of particles 252 further contacts the terrain object 253. Thus, contact between particles and the terrain object 253 and disappearance of the terrain object 253 due to contact occur alternatingly. As a result, the disappeared portion of the terrain object 253 gradually grows larger ((c) shown in FIG. 26). The disappearance condition is also successively satisfied as the deformed object 251 moves, so that the particles successively disappear (e.g., the deformed object 251 becomes gradually smaller). Thus, it is possible to express the terrain object 253 being melted by the deformed object 251. For example, if the deformed object 251 is an object for which an acid material is set and the terrain object 253 is an object for which an iron material is set, it is possible to express iron being dissolved by acid.

As described above, in the present embodiment, the game system 1 determines whether a particle has contacted another object different from the deformed object. Then, if it is determined that a particle has contacted the other object, the contacted portion of the other object is made to disappear from the virtual space. Then, it is possible to express the other object being melted by the deformed object.

Note that in the present embodiment, the game system 1 determines contact between a particle and the other object. Here, in other embodiments, the game system 1 may determine contact between the deformed object and the other object. Note that the determination of contact between the deformed object and the other object may be made using voxel data of the deformed object or may be made using the mesh for the deformed object. Then, if the deformed object is determined to have contacted the other object, the game system 1 causes the contacted portion of the other object to disappear from the virtual space. This can also achieve similar advantageous effects to those of the present embodiment.

In the present embodiment, the game system 1 causes the contacted portion of the other object to disappear from the virtual space at least on the condition that the material set for the deformed object or the existing object and the material set for the other object are in a predetermined combination. For example, where an acid material is set for the deformed object, the game system 1 causes the iron material disappear on the condition that an iron material is set for the other object. Then, it is possible to cause the deformed object to melt a specific object, and to not cause the deformed object to melt any object other than this specific object.

The target object that is influenced by the contact as a result of contacting the deformed object is a voxel object (specifically, a terrain object) in the present embodiment, but in other embodiments, the target object may not be a voxel object. If the target object is not a voxel object, there is no limitation on the method for causing the target object to disappear or change. For example, the game system 1 may cause a portion of the target object to disappear by changing the mesh for the target object.

When the target object is made to disappear, the game system 1 may generate particle data for an area around the portion of the target object that is made to disappear and deform that surrounding area based on the particle data. Then, the game system 1 can express the target object disappearing and the surrounding area changing by melting.

### [3. Specific Example of Process in Game System]

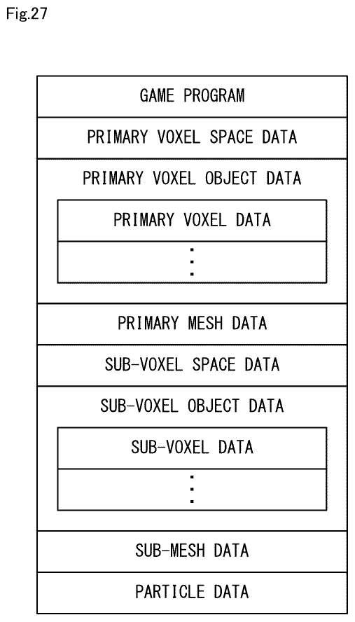

Referring next to FIG. 27 to FIG. 29, specific examples of information processes performed in the game system 1 will be described.

FIG. 27 is a chart showing an example of various data used in information processes performed in the game system 1. As shown in FIG. 27, the game system 1 stores a game program, primary voxel space data, primary voxel object data, primary mesh data, sub-voxel space data, sub-voxel object data, sub-mesh data, and particle data. The game program and the primary voxel space data are data stored in advance on the game system 1 before executing the game process. The game program and the primary voxel space data are stored in a storage medium attached to the slot 23 of the main body apparatus 2, for example. The primary voxel object data, the primary mesh data, the sub-voxel space data, the sub-voxel object data, the sub-mesh data, and the particle data are data that are generated during execution of the game process. These data are stored in the DRAM 85 of the main body apparatus 2, for example.

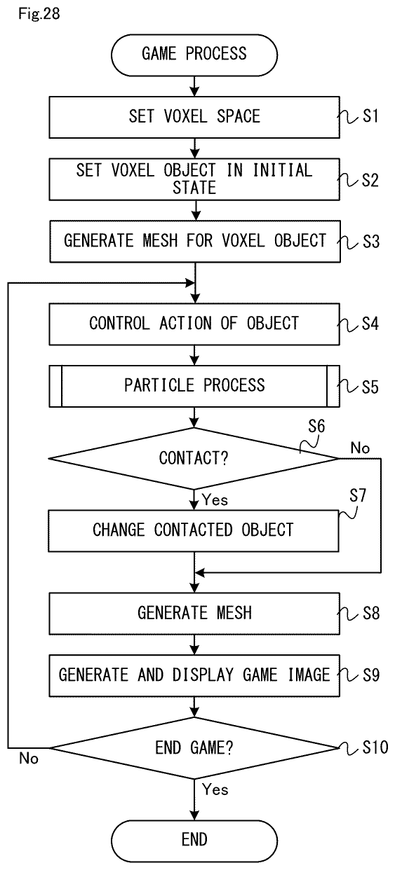

The game program is a game program for executing a game process (specifically, the game process shown in FIG. 28) in the present embodiment.

The primary voxel space data is data that defines a primary voxel space set in the game space. Specifically, the primary voxel space data represents the length of one side of the primary voxel and the direction of each side of the primary voxel in the game space. Where the primary voxel space is set only in a partial region of the game space, the primary voxel space data may include data (e.g., data representing the range of the game space in which the primary voxel is set) that represents the position and the size of the space in which the primary voxel is set (e.g., the primary voxel space).

The primary voxel object data is data that represents a primary object (here, the terrain object) to be arranged in the game space. Specifically, the primary voxel object data includes primary voxel data for each unit area for a part or whole range in the game space.

The primary mesh data is data that represents the mesh set for the primary object arranged in the game space (e.g., the mesh for the terrain object). The primary mesh data includes, for example, data that represents the position of each vertex of the primary mesh.

The sub-voxel space data is data that defines a sub-voxel space set in the game space. Specifically, the sub-voxel space data represents the position and the size of the space in which the sub-voxels are set (e.g., the sub-voxel space), the length of one side of a sub-voxel, and the direction of each side of the sub-voxel in the game space.

The sub-voxel object data is data that represents sub-objects (specifically, the existing object and the deformed object, etc.) to be arranged in the game space. Specifically, the sub-voxel object data includes sub-voxel data for each unit area for a part or whole range in the game space.

The sub-mesh data is data that represents meshes set for sub-objects arranged in the game space (e.g., the mesh for the existing object and the mesh for the deformed object, etc.). The sub-mesh data includes, for example, data representing the position of each vertex of the sub-mesh.

The particle data is data that represents the positions of the particles in the group of particles corresponding to the deformed object. Here, in the present embodiment, a set of the sub-voxel space data, the sub-voxel object data, the sub-mesh data and the particle data is set for each sub-object. That is, when a plurality of sub-objects are arranged in the game space, the game system 1 stores this set for each sub-object. When particle data and the deformed object are generated for an existing object, the game system 1 stores the sub-voxel space data, the sub-voxel object data and the sub-mesh data for the deformed object and the particle data, as a set (e.g., in association with each other).

Note that, in addition to the data shown in FIG. 27, the game system 1 stores the data of the property information and the texture information, the data of the broken piece generation information, and the data related to various characters appearing in the game, as data to be stored in the game system 1 in advance before the game process is executed.

FIG. 28 is a flow chart showing an example of the flow of the game process to be executed by the game system 1. The game process shown in FIG. 28 is started in response to the player giving an instruction to start the game during execution of the game program, for example.

Note that in the present embodiment, it is assumed that the processor 81 of the main body unit 2 executes the game program stored in the game system 1, thereby executing the processes of the steps shown in FIG. 28. Note however that in other embodiments, some of the processes of the steps described above may be executed by another processor (e.g., a dedicated circuit, or the like) different from the processor 81. Where the game system 1 can communicate with another information processing apparatus (e.g., a server), some of the processes of the steps shown in FIG. 28 may be executed in the other information processing apparatus. The processes of the steps shown in FIG. 28 are merely illustrative, and the order of steps to be performed may be switched around or other processes may be executed in addition to (or instead of) the processes of the steps, as long as similar results are obtained.

The processor 81 executes the processes of the steps shown in FIG. 23 to FIG. 27 using a memory (e.g., the DRAM 85). That is, the processor 81 stores information (in other words, data) obtained in each process step in the memory, and when the information is used in a subsequent process step, the information is read out from the memory and used.

In step S1 shown in FIG. 20, the processor 81 sets a voxel space in the game space. Specifically, the processor 81 obtains the voxel space data (specifically, the primary voxel space data and the sub-voxel space data), and stores (in other words, writes) the obtained data in the DRAM 85. Note that in subsequent game processes, the processor 81 may refer to the voxel space data when executing a process related to a voxel object (e.g., the process of step S2, etc.). In this case, the processor 81 refers to the voxel space data stored in the DRAM 85. The process of step S2 is executed, following step S1.

In step S2, the processor 81 sets voxel objects in the game space in the initial state. Specifically, the processor 81 obtains voxel data (specifically, primary voxel data and sub-voxel data) representing the arrangement of voxel objects in the initial state, and stores (in other words, writes) a part or whole of the obtained voxel data in the DRAM 85 as voxel object data (specifically, primary voxel data and sub-voxel object data). Note that voxel data representing the arrangement of voxel objects in the initial state is stored, for example, in a storage medium attached to the slot 23 of the main body apparatus 2. The process of step S3 is executed, following step S2.

Note that the voxel data written to the DRAM 85 as primary voxel object data may be primary voxel data of a partial range of the game space that is used for the generation of the game image, of the primary voxel data for the entire range of the game space. For example, the processor 81 may generate the image of an object by using the primary voxel data only for a partial range of the game space (e.g., the range within a predetermined distance from the position of the virtual camera). In this case, the primary voxel object data may include voxel data within that range. Where the primary voxel data for a partial range of the game space is written, a similar process to step S2 described above is executed at an appropriate point in time during the execution of a series of processes of steps S4 to S10 to be described below (e.g., at a point in time when the position of the virtual camera has moved a predetermined distance or more).

In step S3, the processor 81 generates a mesh for the voxel object. The mesh is generated according to the method described in “[2-2. Mesh]” above. Here, the processor 81 generates a mesh based on the primary voxel object data and the sub-voxel data stored in the DRAM 85, and the mesh in the DRAM 85 as primary mesh data or sub-voxel data. Through the process of step S3, voxel objects have been constructed in the game space. After step S3 described above, the game starts, and a series of processes of steps S4 to S10 is repeatedly executed in the game.

In step S4, the processor 81 controls the action of various objects (e.g., the player object and enemy objects) that appear in the game space. For example, the processor 81 controls the action of the player object based on operation data received from the controller 3 or 4, or controls the action of the enemy objects based on an algorithm defined in the game program. The process of step S5 is executed, following step S4.

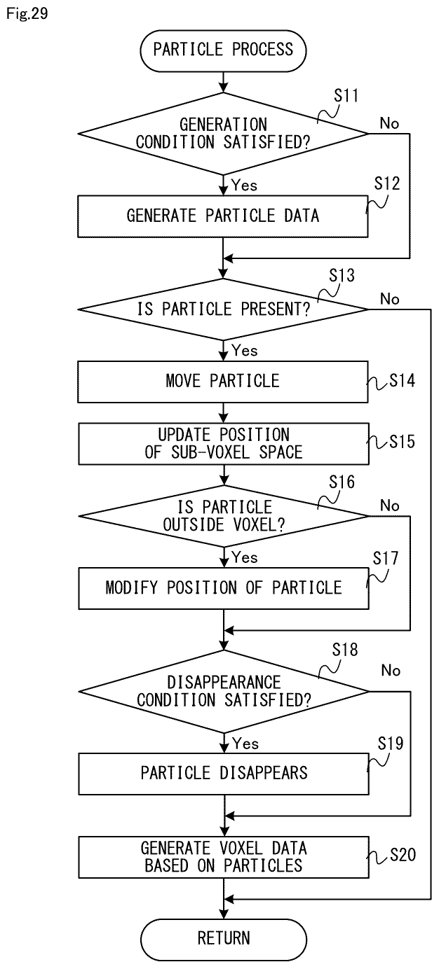

In step S5, the processor 81 executes the particle process so as to generate and update particle data. The detailed flow of the particle process will now be described with reference to FIG. 29.

FIG. 29 is a sub-flow chart showing an example of the detailed flow of the particle process in step S5 shown in FIG. 28. In the particle process, first, in step S11, the processor 81 determines whether the generation condition is satisfied for the sub-objects arranged in the game space. Note that the generation condition may be set for each sub-object and may be different for each sub-object. The determination result from step S11 is affirmative when it is determined that the generation condition is satisfied for at least one sub-object, whereas the determination result from step S11 is negative when there is no sub-object for which the generation condition is determined to be satisfied. When the determination result from step S11 is affirmative, the process of step S12 is executed. On the other hand, if the determination result from step S11 is negative, the process of step S13 is executed, skipping the process of step S12.

In step S12, the processor 81 generates particle data corresponding to sub-objects (e.g., existing objects) for which the generation condition is satisfied. Specifically, the processor 81 generates particle data representing the positions of a group of particles arranged so as to correspond to the shape of the existing object by the method described in “[2-4. Deformation process using particle data]” above. In this process, the processor 81 stores the generated particle data in the DRAM 85 while associating the particle data with sub-voxel object data related to the existing object. When generating particle data for a specific existing object, the processor 81 sets target positions for particles and stores the target position data representing the target positions in the DRAM 85. The process of step S13 is executed, following step S12.

In step S13, the processor 81 determines whether a particle is present in the game space. If the determination result from step S13 is affirmative, the process of step S14 is executed. On the other hand, if the determination result from step S13 is negative, the processor 81 ends the particle process.

In step S14, the processor 81 moves the group of particles arranged in the game space. In this process, the processor 81 updates the particle data stored in the DRAM 85 so as to represent the positions of the particles having been moved. As described in “[2-4. Deformation process using particle data]” above, each particle may be moved according to the physical laws applied in the game space, or based on the target position set for the particle. Note that in a single iteration of the process of step S14, one iteration of the moving process (e.g., the process of moving each particle for one frame) is executed. Then, by repeating the process of step S14, the processor 81 calculates the change over time of the position of each particle in the group of particles, and successively updates the particle data based on the calculation result. The process of step S15 is executed, following step S14.

In step S15, the processor 81 updates the position of the sub-voxel space corresponding to a group of particles arranged in the game space. Note that the “sub-voxel space corresponding to a group of particles” is the sub-voxel space related to the deformed object generated based on the group of particles. Specifically, the processor 81 calculates the updated position of the sub-voxel space based on the group of particles by the method described in “[2-4. Deformation process using particle data]” above. In this process, the processor 81 updates the sub-voxel space data stored in the DRAM 85 so as to represent the updated position. The process of step S16 is executed, following step S15.

In step S16, the processor 81 determines whether or not any of the particles included in the group of particles arranged in the game space are located outside the sub-voxel space corresponding to the group of particles. This determination can be made by referring to the particle data stored in the DRAM 85 and the sub-voxel space data associated with the particle data. If the determination result from step S16 is affirmative, the process of step S17 is executed. On the other hand, if the determination result from step S16 is negative, the process of step S18 is executed, skipping the process of step S17.

In step S17, the processor 81 modifies the position of the particle determined to be located outside the sub-voxel space in step S17. Specifically, the processor 81 modifies the position of the particle so that the particle is located within the sub-voxel space by the method described in “[2-4. Deformation process using particle data]” above. In this process, the processor 81 updates the particle data stored in the DRAM 85 so as to indicate the position of the particle having been modified. The process of step S18 is executed, following step S17.

In step S18, the processor 81 determines whether the disappearance condition is satisfied for the particles arranged in the game space. Note that the disappearance condition may be set for each deformed object (which can be said to be for each existing object) and may be different for each deformed object. The determination result from step S18 is affirmative if the disappearance condition is determined to be satisfied for at least one particle, and the determination result from step S18 is negative if there is no particle for which the disappearance condition is determined to be satisfied. If the determination result from step S18 is affirmative, the process of step S19 is executed. On the other hand, if the determination result from step S18 is negative, the process of step S20 is executed, skipping the process of step S19.

In step S19, the processor 81 causes particles for which the disappearance condition is satisfied to disappear. Specifically, the processor 81 updates the particle data stored in the DRAM 85 so as to delete the positions of particles for which the disappearance condition is satisfied. The process of step S20 is executed, following step S19 is executed.

In step S20, based on a group of particles arranged in the game space, the processor 81 generates voxel data related to the deformed object corresponding to the group of particles (or “updates voxel data” if the voxel data related to the deformed object has already been generated). Specifically, the processor 81 generates voxel data related to the deformed object so that the density represented by the voxel data corresponds the positions of the particles included in the group of particles by the method described in “[2-4. Deformation process using particle data]” above. In this process, the processor 81 updates the sub-voxel object data related to the deformed object so as to be the content of the generated voxel data. After step S20, the processor 81 ends the particle process.

Returning back to FIG. 28, in step S6 following the particle process of step S5, the processor 81 determines whether a particle has contacted another object. If the determination result from step S6 is affirmative, the process of step S7 is executed. On the other hand, if the determination result from step S6 is negative, the process of step S8 is executed, skipping the process of step S6.

In step S7, the processor 81 changes the object that has been contacted by the particle in accordance with the contact. For example, as the change in accordance with the contact, the processor 81 changes the material of the contacted portion of the object (see FIG. 19) or makes the contacted portion disappear (FIG. 26). The processor 81 updates the primary voxel object data or the sub-voxel object data related to the object that has been contacted by the particle stored in the DRAM 85 so as to represent the state having been changed. The process of step S8 is executed, following step S7.

In step S8, the processor 81 updates the mesh for the voxel object whose voxel data has been changed in step S5 or S7 described above. That is, for the deformed object whose voxel data has been updated in step S5 and the object whose voxel data has been updated in step S7 (e.g., the object that has been contacted by the particle), the processor 81 generates a mesh based on the updated voxel data. Thus, it is possible to dynamically change the mesh for the voxel object in the game. Note that the processor 81 updates the mesh data stored in the DRAM 85 (e.g., the primary mesh data and the sub-mesh data) so as to represent the mesh newly generated. The process of step S9 is executed, following step S8.

In step S9, the processor 81 generates a game image representing the game space and displays the game image on the display device. Specifically, the processor 81 generates a game image representing the game space including voxel objects and other objects (e.g., the player object and enemy objects). Note that the image of a voxel object is generated according to the method described in “[2-2. Mesh]” above using the voxel object data and the mesh data stored in the DRAM 85. The processor 81 displays the generated game image on the display device. Note that in the game, the process of step S9 is repeatedly executed at a rate of once per a predetermined amount of time (e.g., one frame time). The process of step S10 is executed, following step S9.

In step S10, the processor 81 determines whether or not to end the game. For example, the processor 81 determines whether or not an instruction to end the game has been given by the user. If the determination result from step S10 is negative, the process of step S4 is executed again. Thereafter, a series of processes of steps S4 to S10 is executed repeatedly until it is determined in step S10 to end the game. On the other hand, if the determination result from step S10 is affirmative, the processor 81 ends the game process shown in FIG. 28.

### [4. Functions/Effects and Variations of Present Embodiment]

Thus, in the embodiment described above, the information processing system (specifically, the game system 1) includes the following units:
a particle generator configured to generate particle data including data representing positions of a plurality of particles that correspond to a shape of an existing object, which is an object arranged in a virtual space (step S12);
a particle calculator configured to calculate change over time of the positions of the plurality of particles and update the particle data based on the calculation result (step S14);
a voxel data generator configured to generate voxel data related to a voxel object, which has a shape corresponding to the positions of the plurality of particles, based on the particle data (step S20);
a mesh generator configured to generate a mesh for the voxel object based on the voxel data (step S8); and
an image generator configured to generate an image that is obtained by rendering the mesh in the virtual space so as to output the generated image to a display device (step S9).

According to this configuration, an existing object can be deformed over time using particle data. Moreover, by calculating the change over time of the positions of the particles, it is possible to express natural deformation of the object.

Note that the embodiment described above is directed to an example where the existing object is a voxel object. That is, in the embodiment described above, the existing object is an object that is generated based on voxel data generated prior to the generation of the particle data related to the existing object (which can also be said to be an object generated based on voxel data that is different from the voxel data of the deformed object generated based on this particle data). Thus, with the embodiment described above, it is possible to express natural deformation of voxel objects by using particles.

Now, in other embodiments, the existing object may be an object that is not a voxel object. Note that when generating a group of particles corresponding to an existing object that is not a voxel object, the game system 1 may determine whether or not an existing object is present in the particle region based on the mesh of the existing object, and arrange particles in the particle region where the existing object is present, thereby generating a group of particles.

Note that in other embodiments, the information processing system does not need to include one or more of the components of the embodiment described above and does not need to execute one or more of the processes that are executed in the embodiment described above. For example, in order to realize a specific one of the advantageous effects of the embodiment described above, the information processing system may include a component or components for realizing the specific advantageous effect and execute a process or processes for realizing the specific advantageous effect, and the information processing system does not need to include other components and does not need to execute other processes.

The embodiment described above can be used as, for example, a game system and a game program, with the aim of, for example, deforming over time an existing object arranged in a virtual space using particles.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute information processing comprising:
generating particle data including data representing positions of a plurality of particles that correspond to a shape of an existing object, which is an object arranged in a virtual space;
calculating change over time of the positions of the plurality of particles and updating the particle data based on the calculation result;
generating voxel data related to a voxel object, which has a shape corresponding to the positions of the plurality of particles, based on the particle data;
generating a mesh for the voxel object based on the voxel data; and
generating an image that is obtained by rendering the mesh in the virtual space so as to output the generated image to a display device.

2. The non-transitory computer-readable storage medium according to claim 1, wherein the existing object is an object generated based on voxel data that is generated before the particle data related to the existing object is generated.

3. The non-transitory computer-readable storage medium according to claim 1, wherein the particle data is generated based on whether or not at least a part of the existing object is present in each of a plurality of unit regions that are obtained by partitioning a region including the existing object in the virtual space into a grid.

4. The non-transitory computer-readable storage medium according to claim 3, wherein a length of one side of the unit region is equal to a length of one side of a voxel corresponding to the voxel data generated based on the particle data.

5. The non-transitory computer-readable storage medium according to claim 1, wherein the particle data is updated so that at least some of the plurality of particles disappear in response to satisfaction of a disappearance condition.

6. The non-transitory computer-readable storage medium according to claim 1, wherein:
the particle data is updated repeatedly; and
a value of the current particle data is calculated, which represents new positions of the plurality of particles, by using the previously updated particle data, without using the voxel data generated based on the previously updated particle data.

7. The non-transitory computer-readable storage medium according to claim 1, wherein the information processing further comprises: updating a range of a voxel space, in which voxels related to the voxel data generated based on the particle data are set, based on the updated particle data.

8. The non-transitory computer-readable storage medium according to claim 1, wherein the positions of the plurality of particles are controlled so that the particles are located within a voxel space, in which voxels related to the voxel data generated based on the particle data are set.

9. The non-transitory computer-readable storage medium according to claim 1, wherein the particle data corresponding to the existing object is generated in response to the existing object contacting a first object different from the existing object.

10. The non-transitory computer-readable storage medium according to claim 9, wherein the particle data corresponding to the existing object is generated at least on a condition that a material set for the existing object and a material set for the first object are in a predetermined combination.

11. The non-transitory computer-readable storage medium according to claim 1, wherein the information processing further comprises:
determining whether or not the particles have contacted a second object different from the voxel object or whether or not the voxel object has contacted the second object; and
if it is determined that the particles have contacted the second object or if it is determined that the voxel object has contacted the second object, causing a portion of the second object that has been contacted to disappear from the virtual space.

12. The non-transitory computer-readable storage medium according to claim 11, wherein the contacted portion of the second object disappears from the virtual space at least on a condition that a material set for the voxel object or the existing object and a material set for the second object are in a predetermined combination.

13. The non-transitory computer-readable storage medium according to claim 1, wherein the particle data is updated so that the plurality of particles move over time toward destination positions that are set respectively for the plurality of particles.

14. The non-transitory computer-readable storage medium according to claim 13, wherein:
the information processing apparatus stores data representing target positions of the plurality of particles, which are positions of the particles after change over time; and
the destination positions are set based on the target positions, and the particle data is updated until the plurality of particles reach the respective target positions.

15. The non-transitory computer-readable storage medium according to claim 14, wherein:
the information processing apparatus stores post-change data related to a shape of an object after the existing object has changed over time;
a mesh for the voxel object is generated based on the voxel data based on the particle data at least until the plurality of particles reach the respective target positions; and
at a predetermined point in time after the plurality of particles have reached the respective target positions, mesh generation based on the voxel data based on the particle data is ended, and a mesh is generated based on the post-change data.

16. An information processing system, comprising one or more processors that are configured to execute information processing comprising:
generating particle data including data representing positions of a plurality of particles that correspond to a shape of an existing object, which is an object arranged in a virtual space;
calculating change over time of the positions of the plurality of particles and update the particle data based on the calculation result;
generating voxel data related to a voxel object, which has a shape corresponding to the positions of the plurality of particles, based on the particle data;
generating a mesh for the voxel object based on the voxel data; and
generating an image that is obtained by rendering the mesh in the virtual space so as to output the generated image to a display device.

17. An information processing apparatus comprising one or more processors that execute information processing, the information processing comprising:
generating particle data including data representing positions of a plurality of particles that correspond to a shape of an existing object, which is an object arranged in a virtual space;
calculating change over time of the positions of the plurality of particles and update the particle data based on the calculation result;
generating voxel data related to a voxel object, which has a shape corresponding to the positions of the plurality of particles, based on the particle data;
generating a mesh for the voxel object based on the voxel data; and
generating an image that is obtained by rendering the mesh in the virtual space so as to output the generated image to a display device.

18. An information processing method performed on an information processing system, the information processing method comprising:
generating particle data including data representing positions of a plurality of particles that correspond to a shape of an existing object, which is an object arranged in a virtual space;
calculating change over time of the positions of the plurality of particles and update the particle data based on the calculation result;
generating voxel data related to a voxel object, which has a shape corresponding to the positions of the plurality of particles, based on the particle data;
generating a mesh for the voxel object based on the voxel data; and
generating an image that is obtained by rendering the mesh in the virtual space so as to output the generated image to a display device.
